(19) United States
(12) Patent Application Publication
(10) Pub. No.: US 2002/0133634 A1
(43) Pub. Date: Sep. 19, 2002

(54) Thin client solutions with HMI systems

(76) Inventor: Jurgen Bieber, Ettlingen (DE)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/812,205

(22) Filed: Mar. 19, 2001

(51) Int. Cl. G06F 15/163; G06F 9/54; G06F 9/00; G06F 15/16; G06F 9/445

(52) U.S. Cl. 709/310; 709/203; 717/176

(57) ABSTRACT

A control program is provided on a network server, and a plurality of parallel instances of the control program are deployed to a respective plurality of thin client terminals over a network. A process is then independently controlled from each of the plurality of thin client terminals, thereby providing multiple terminal server-client operation.

### Background of the Invention

The present invention is directed to the field of “operator communication and monitoring systems” for an automated production plant using a Human Machine Interface (HMI) system. It has become common in production plant operations to use so-called “Client Server” technologies to enable several operators to monitor and, if necessary, operate a production plant simultaneously. The server performs the entire numerical control, and also establishes the connection via the process data highway to the automation devices, and receives, processes and archives the transmitted process data. The clients, also called terminals, are primarily used to control the graphics output, to enable operator inputs or image changes via mouse and keyboard.

Such typical systems suffer from several disadvantages. Each client terminal requires a separate installation and configuration of the communication and monitoring software, and each terminal must also be upgraded separately. Also, the communication and monitoring software results in restrictions on the operating system platform and/or the hardware requirements, in order to properly function. As a result, when software is upgraded or when special software components are used (such as ActiveX controls) each operator terminal must also be upgraded. This presents a burden to the end-user, since such upgrades result in additional costs for installation, startup, testing, maintenance and service at the system, not to mention clumsy handling, as each terminal must be handled on an individual basis.

### SUMMARY OF THE INVENTION

In view of the difficulties and drawbacks associated with previous systems, there is a need for a distributed communication and monitoring system that permits simultaneous installation and upgrades to all clients.

There is also a need for a distributed communication and monitoring system that increases efficiency and reduces costs associated with system installation and maintenance.

There is also a need for a distributed communication and monitoring system that permits software deployment on a variety of hardware and operating system configurations.

These needs and others are satisfied by the present method of independent process control. A control program is provided on a network server, and a plurality of parallel instances of the control program are deployed to a respective plurality of thin client terminals over a network. A process is then independently controlled from each of the plurality of thin client terminals, thereby providing multiple terminal server-client operation.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 shows a client server system in accordance with the present invention.

FIG. 2 shows an alternative client server system in accordance with the present invention.

### DETAILED DESCRIPTION OF THE INVENTION

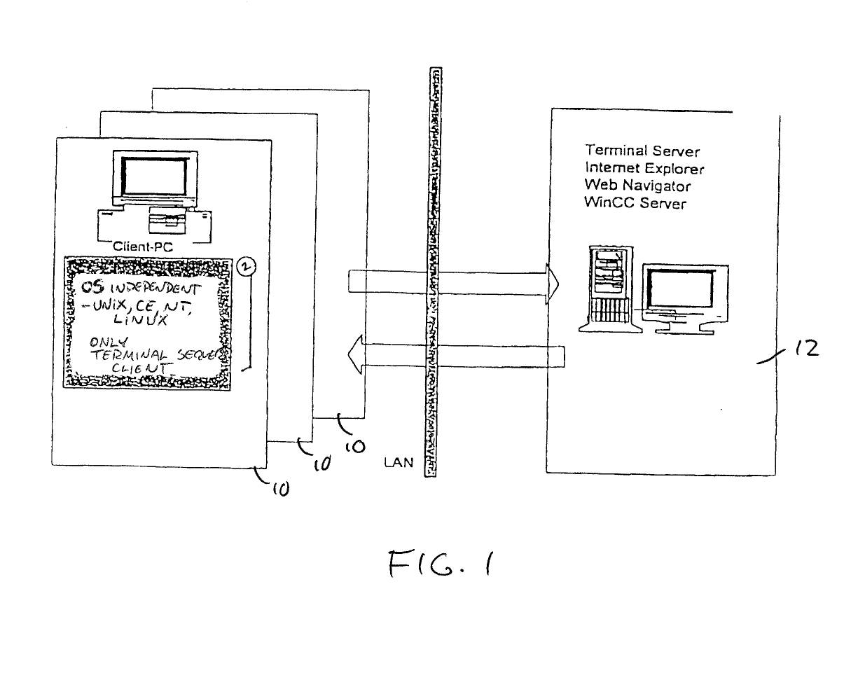

As shown in FIG. 1, the present invention overcomes the drawbacks associated with previous systems preferably by utilizing a plurality of thin clients 10, i.e. a network computer not having a hard drive. Alternatively, the invention can employ a client having a hard drive not used for network communication and monitoring systems. In any case, a server 12 is provided for maintaining a control program, preferably an operator communication and monitoring program used for process control in an automated production plant. The server 12 displays parallel, multiple instances of the control program, which are released and installed over a local area network (LAN) onto the clients 10 with each initialization of the network. For a thin client, the control program is deployed along with operating system with each initialization. In this manner, the present method allows independent control over the process from each of the thin clients 10, thereby providing multiple terminal server-client operation.

In the preferred embodiment, the control program is “WinCC” (Windows Control Center, developed by Siemens A. G.), a supervisory control and data acquisition HMI application used for operation in an automated production plant environment. In the preferred embodiment, the WinCC control program is deployed using the “Terminal Server” software provided by Microsoft Corp. This software enables the use of Terminal Server Client Solutions on various operating system platforms (including Windows CE and UNIX).

The principle of this solution is based on deploying parallel, multiple instances of the control software. The various Terminal Server Clients 10 establish contact with the Terminal Server 12, which releases and installs respective copies of the control software. Except for the small Terminal Server Client Software and the operating system (which both come down from the server 12) no other software is installed on the client computers 10, and so the software does not have to be reinstalled or maintained, unless the network is reinitialized. In this way, the available software and the software to be maintained for all clients 10 is only installed and upgraded on the server 12.

The WinCC control software does not allow for multiple independent instances to be deployed on multiple client terminals. Consequently, this problem is solved by using an intermediate software layer for creating a plurality of independent instances of WinCC. This can be realized by deploying WinCC in connection with a web navigator application.

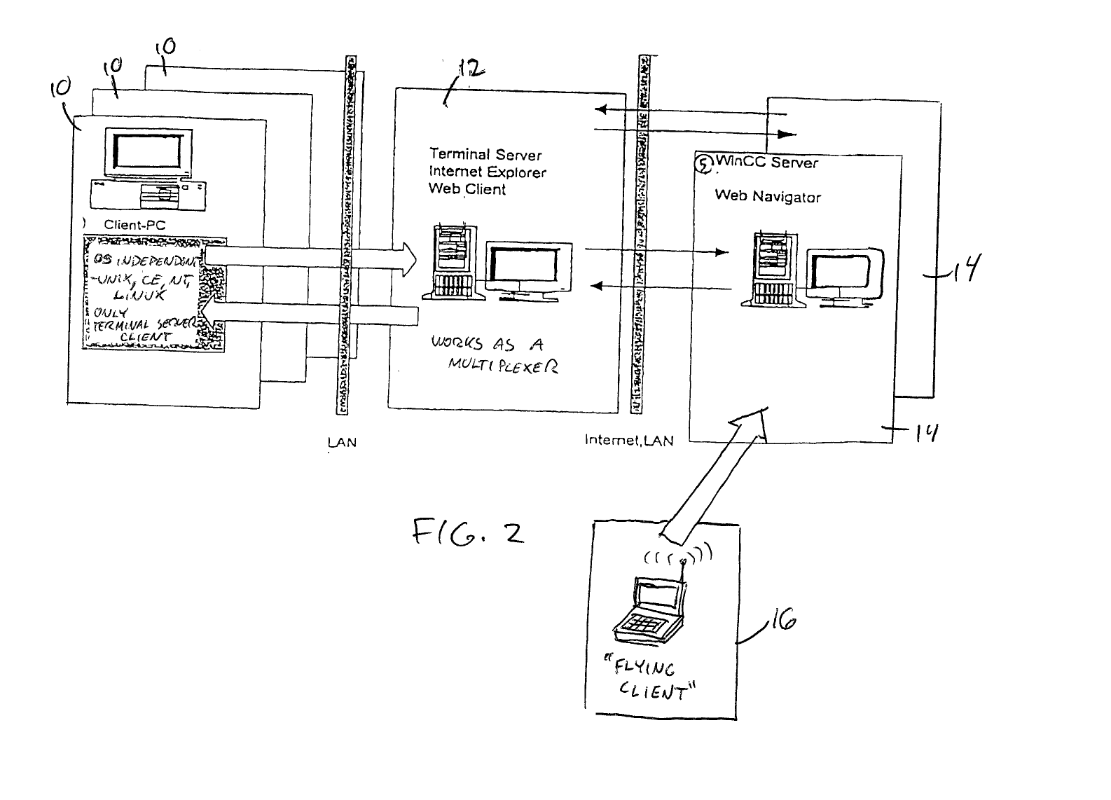

As shown in FIG. 2, one or more separate servers 14 can be used for deploying the WinCC and web navigator applications. In the preferred embodiment, Microsoft Internet Explorer is used as the web navigator application. This application can be deployed from the server 14 to the terminal server 12 and then to the clients 10. WinCC is then deployed from its own server 14 to the terminal server 12 and onto the clients 10. The terminal server 12 functions as a multiplexer for these two corrections. WinCC can be run by Internet Explorer as an Active X control. As a result, each client 10 connects to WinCC via the navigator to perform all process control tasks. Each client 10 runs a separate copy of the web navigator software, which then opens its own copy of WinCC. In this manner, multiple instances can be deployed to each client 10, and operators at each of these clients 10 can independently establish control over the process control, separate from other operators.

The connection to the WinCC and web navigator servers 14 can be made over the LAN, or from a remote location over the Internet. For the user, the benefits of this system include that WinCC or other control software can now be run as a client on other operating systems, such as Windows CE, Linux, and Unix. As a result, available hardware can be employed, and all software maintenance and service can be performed on the server 12, and no longer on the client terminals 10.

In addition to the above, by using the terminal server 12 as an intermediate station or multiplexer, a further degree of distribution can be realized, since the clients 10 can also access various other additional servers, as needed. As a result, the client terminals 10 can be used to operate and monitor more than one operation and communication server 12. With this multiplexer scenario, it would be possible to reach different servers from the client side and to avoid the heavy load on the servers in the plant, since the load will just be on the multiplex server 12 (or MUX-server). In the event that the load is too much for the MUX-server 12, or if the MUX-server 12 fails, then the server in the plant is unaffected. The plant server is still free to control the machines and robotic functions, and can additionally archive process data and handle alarm situations. In this way, the plant server performs its major functions with the risk of interruptions to production.

In another aspect of the invention, the present method allows a “flying terminal” implementation. A flying terminal 16 can be a portable Windows CE unit, e.g., a laptop or other mobile computing device. This device 16 includes a pre-loaded copy of terminal server client software, and a remote connection to the WinCC server 14. The user can thus remotely access the server 14 for start-up, diagnostic and fault analysis, and also control functions. In this way, the user can access all communication and monitoring functions (including alarms, archives and diagnostic images) and thereby analyze the signal paths or faults more cost effectively, without relying on another system driver on the server 12.

With this aspect of the invention, a user can walk through a production plant with a flying client 16, which can be a PAD, laptop or other small mobile CE device with a wireless connection to the WinCC server 14, and having just the small footprint of the terminal client software with the remote connection. The process can be controlled and changed from the flying client 16. In this way, the plant operators can control the machines and change the process/production while standing in front of the machines, or can repair the machines while consulting the screen on the flying client 16. This is an improvement over the common-type implementation of fixed client terminal stations, hard-wired at locations near the machines. A single flying client 16 can be used to monitor a number of machines, thus reducing the expense of having dedicated hard-wired terminals near each machine.

As a result of the disclosed configuration and software realization, all of the above-listed disadvantages are solved for end-users, and the introduction of standard software for client solutions produce further advantages such as scalability and security.

As described hereinabove, the present invention solved many problems associated with previous type apparatuses. However, it will be appreciated that various changes in the details, materials and arrangements of parts which have been herein described and illustrated in order to explain the nature of the invention may be made by those skilled in the art within the principle and scope of the invention will be expressed in the appended claims.

I claim:

1. A method of independent process control comprising the steps of:
providing a control program on a network server;
deploying a plurality of parallel instances of the control program to a respective plurality of thin client terminals over a network; and
independently controlling a process from each of the plurality of thin client terminals, thereby providing multiple terminal server-client operation.

2. The method of claim 1 wherein the step of deploying comprises using an intermediate software layer for creating the plurality of instances of the control program.

3. The method of claim 2 wherein the control program is an automated production process control program.

4. The method of claim 1 wherein the plurality of the clients utilize at least one of a plurality of different operating systems.

5. The method of claim 5 wherein the plurality of different operating systems comprise Windows, Linus, Unix and Macintosh operating systems.

6. The method of claim 1 wherein at least one of the plurality of client terminals is a flying client having a wireless connection to the network.
